(19) United States
(12) Patent Application Publication
(10) Pub. No.: US 2025/0295079 A1
(43) Pub. Date: Sep. 25, 2025

(54) Wire Trellis Lock and Method of Use

(71) Applicants: Jeff Koenig, Aurora, OR (US); Tate Koenig, Aurora, OR (US); Matt Poeschi, Aurora, OR (US)

(72) Inventors: Jeff Koenig, Aurora, OR (US); Tate Koenig, Aurora, OR (US); Matt Poeschi, Aurora, OR (US)

(73) Assignee: The Inventor's Club LLC, Aurora, OR (US)

(21) Appl. No.: 18/611,204

(22) Filed: Mar. 20, 2024

(51) Int. Cl. A01G 9/12; A01G 17/08; F16B 2/22; F16B 37/16

(52) U.S. Cl. CPC A01G 9/128; A01G 17/08; F16B 2/22; F16B 37/16

(57) ABSTRACT

A wire trellis lock that can quickly be affixed a plethora of different sized horizontal trellis wires, and can accommodate connection to a range of plant trunk sizes so as to prevent the bending or blowing over of the plant. The trellis lock is made of few components, basically a trellis lock body, at least one speed strap, and a wing nut. The trellis lock body has an insert affixed on its back face to prevent scarring to the trunk of the plant. In use, the horizontal trellis wire of a nursery is frictionally locked to the trellis lock between the trellis lock body and a flange on the wingnut. The trellis lock body secured to the trellis wire is affixed to the truck or stalk of a plant by at least on elastic speed strap.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to devices for efficient plant nursery operation, and more particularly to plant stability technology.

### BACKGROUND

In a plant nursery, the taller plants, generally young saplings, grow in pots and are susceptible to blowing over or at least, to being bent over in high wind conditions. The bending over aspect is generally rectified by inserting a linear member (generally a wooden rod) into the pot, parallel to the linear axis of the plant's trunk, and securing a tie of some sort around the rod and trunk. However, the blowing over aspect is cured by a linear member inserted in the ground aside the plant and secured to the plant or the pot.

This time consuming for the erection of the linear members and for their removal for sale or movement of the plant. Additionally, the insertion of new plants may require relocating of multiple plants to obtain room for the additional plant.

Henceforth, a device that both stabilized the plant from bending or blowing over would fulfill a long felt need in the tree nursery industry. This new invention utilizes and combines known and new technologies in a unique and novel configuration to overcome the aforementioned problems and accomplish this. A more economical and quick solution is provided by the embodiment set forth below.

### BRIEF SUMMARY

In accordance with various embodiments, a wire trellis lock for plants is provided.

In one aspect, a four piece UV and chemical resistant polymer wire trellis lock (“trellis lock”) that can withstand extreme temperatures is provided.

In another aspect, a polymer trellis lock with a soft insert that contacts the plant trunk without scarring, and quick release stretch bands for securement to the trunk, is provided.

In yet another aspect, a re-useable, tool-less device for quick and efficient crop rotation or individual removal/replacement, is provided.

In yet another aspect, a wire trellis lock that can accommodate conventional trellis wire sizes from 16 gauge to ½/inch thick, is provided.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a front view of the trellis lock body;

FIG. 2 is a rear view of the trellis lock body;

FIG. 3 is a top view of the trellis lock body;

FIG. 4 is a bottom view of the trellis lock body;

FIG. 5 is a right-side view of a speed strap;

FIG. 6 is a left-side view of a speed strap;

FIG. 7 is a front view of a speed strap;

FIG. 8 is a rear view of a speed strap;

FIG. 9 is a top view of a trellis wing nut;

FIG. 10 is a bottom view of a trellis wing nut;

FIG. 11 is a front view of a trellis wing nut;

FIG. 12 is a back view of a trellis wing nut;

FIG. 13 is a front view of an assembled trellis lock;

FIG. 14 is a back view of an assembled trellis lock;

FIG. 15 is a left-side view of an assembled trellis lock; and

FIG. 16 is a right-side view of an assembled trellis lock.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise indicated, all numbers herein used to express quantities, dimensions, and so forth, should be understood as being modified in all instances by the term “about.” In this application, the use of the singular includes the plural unless specifically stated otherwise. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “trellis” refers to at least one flexible linear member (generally a metal trellis wire or cable), drawn taut between vertical supports, so as to reside in a horizonal configuration, generally parallel to linear rows of plants, potter or otherwise.

As used herein, the terms “longitudinal axis and transverse axis” refer to the longest axis of a body and transverse refers to the axis of a body perpendicular to the longitudinal axis.

As used herein, the term “wingnut” refers to any type of speednut or mechanical fastening means that may be hand tightened to operational securement without the need for tools. It may have multiple wings or one wing extending therefrom to allow sufficient torque to be developed by hand.

The present invention relates to a novel design for a wire trellis lock that can quickly be affixed to a horizontal trellis wire, and accommodate a range of plant trunk sizes so as to prevent the bending or tipping over of the plant without scarring the plant trunk. In the preferred embodiment, all elements are UV resistant polymers, although other materials may be used, polymers are the most cost effective, anti-weathering, anti-rusting and re-useable choice. In the preferred embodiment, the wingnut and body of the trellis lock are rigid having a Shore A Scale durometer of 70-100. The body insert bumper is more forgiving (slightly compressible and grippy) having a Shore A Scale durometer of 20-60 and the speed straps have a Shore A Scale durometer of 10 -50.

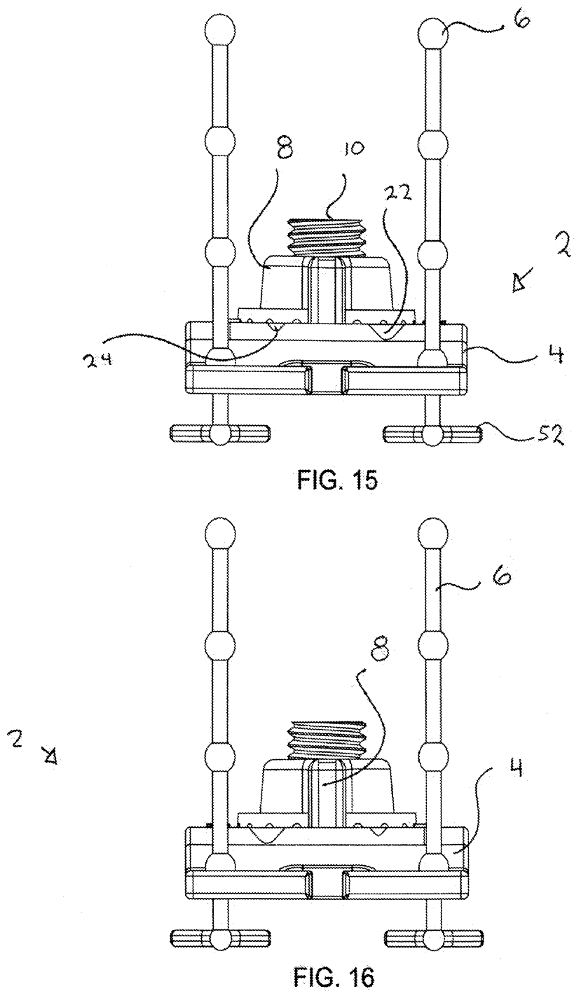

Looking at FIGS. 15 and 16, it can be seen that the trellis lock 2 is made of three components, the trellis lock body 4, at least one elastic speed strap 6 (preferably two) and the wing nut 8. The trellis lock body 4 has an insert 18 affixed on its back face 12 to prevent scarring to the trunk of the plant. (FIG. 2)

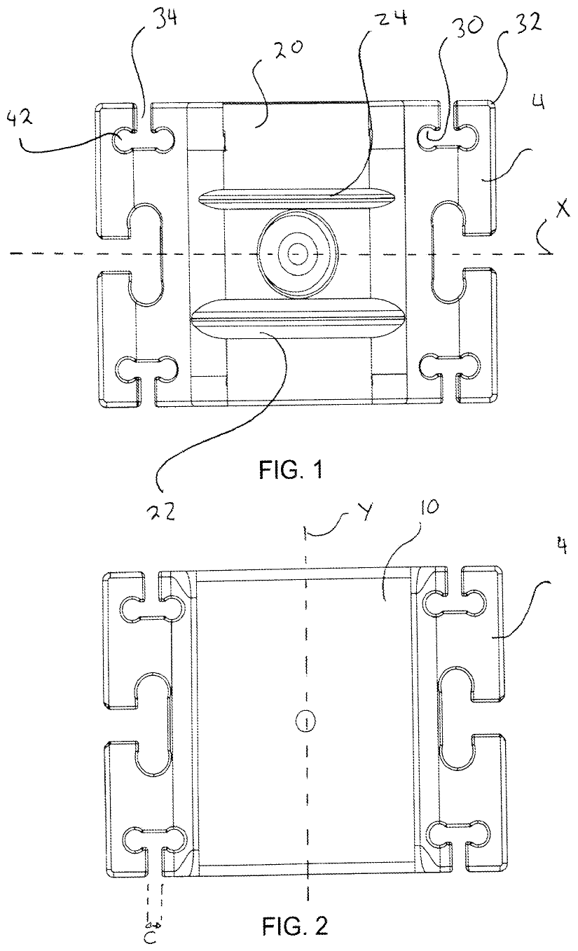

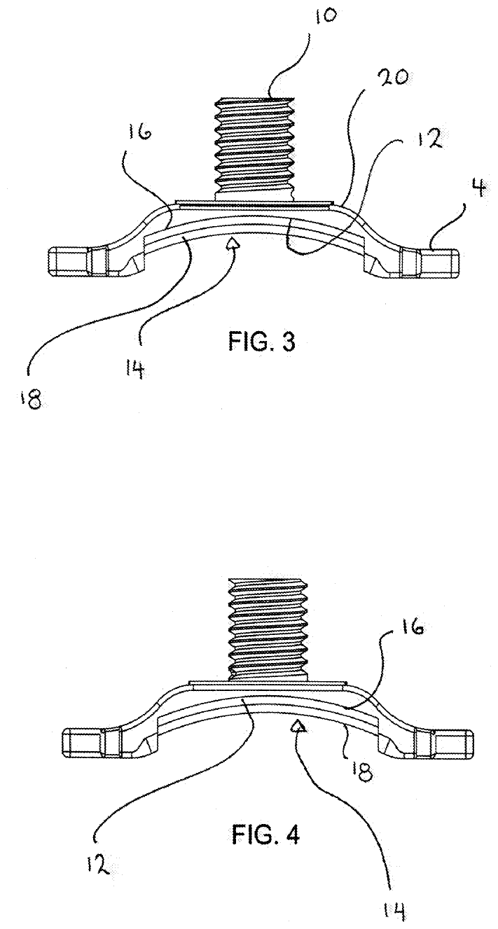

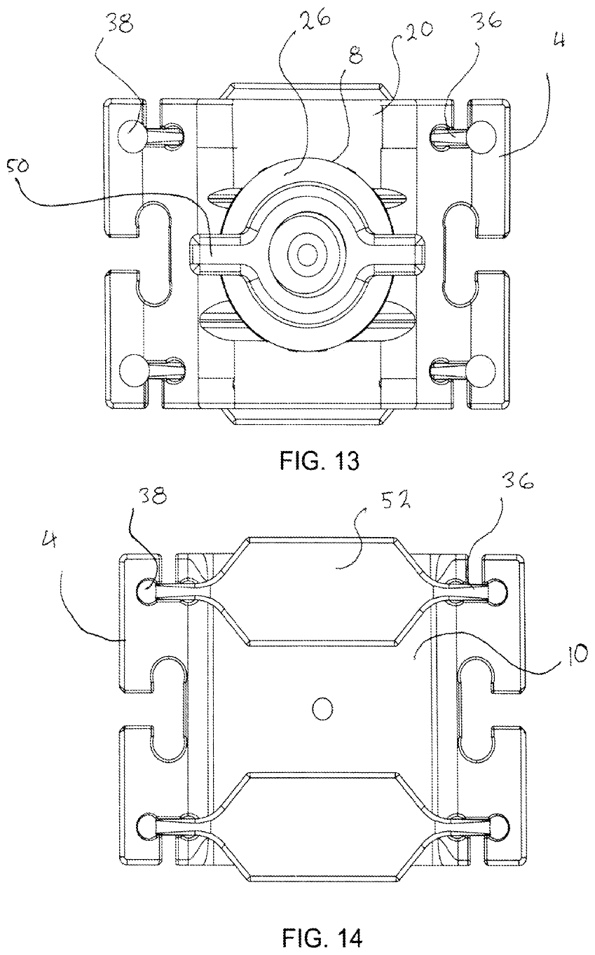

The trellis lock body 4 is best explained looking at FIGS. 1, 2, 3, 4, 13 and 14. The trellis lock body 4 has a rectangular profile that has a concave arced section 14 formed centrally on its rear face 12, along its entire transverse axis (designated as line Y on FIG. 2). This concave arced section 14 has a concave cutout 16 into which an insert 18 is affixed. This bond may be chemical or mechanical (such as a polymer adhesive) although the preferred method of affixment is by a second shot of injection molding around barbs that were formed on the concave cutout. The insert 18 is the part of the trellis lock 2 that contacts the trunk of the plant and as such is made of a polymer with a more compressible material (a lower Shore A Scale durometer reading) than the trellis lock body 4 so that any friction or rubbing between the trunk and the trellis lock 2 will not scar the plant's trunk.

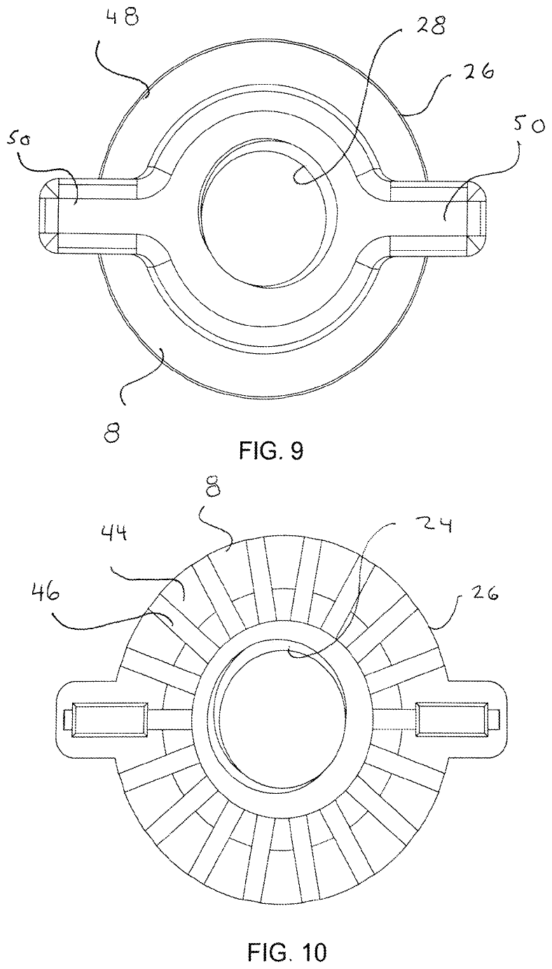

Formed centrally and perpendicularly to the plane of the front face 20 of the trellis lock body extends a first half mechanical fastener 10 which is a threaded stud 10 in the preferred embodiment. This first half mechanical fastener 10 is sized for engagement with a second half mechanical fastener 8, which in the preferred embodiment is a flanged wing nut with an internal thread 28. (FIGS. 9 and 10) There are four T shaped slots 30 formed adjacent to the four corners 32 of the trellis lock body 4. The entry channels 34 of the T shaped slots 30 reside parallel to the transverse axis Y and are sized to frictionally allow the entry and passage of the speed straps band 36. When the bands 36 of the speed strap 6 are slid into the T shaped slot's entry channels 34 they will be slid to the sides 42 of the slot 30 where they will be restrained by the retention spheres 38 of the speed strap 6.

Running parallel with the longitudinal axis of the trellis lock body 4 are two wire grooves. The first wire groove 22 is formed in the front face 20 of the trellis lock body 4 on one side of the stud 10. The second wire groove 24 is formed on the other side of the stud 10 and resides parallel to the first wire groove 22. The wire grooves have a different depth profile. The first wire groove 22 has a depth profile that accommodates trellis wires up to ½ inch in diameter (for longer trellises) and the second wire groove 24 has a depth profile that accommodates trellis wires down to 16 gauge wire. Each of these wire grooves 22 and 24 are closer to the stud 10 than the outer periphery 26 of the wing nut 8.

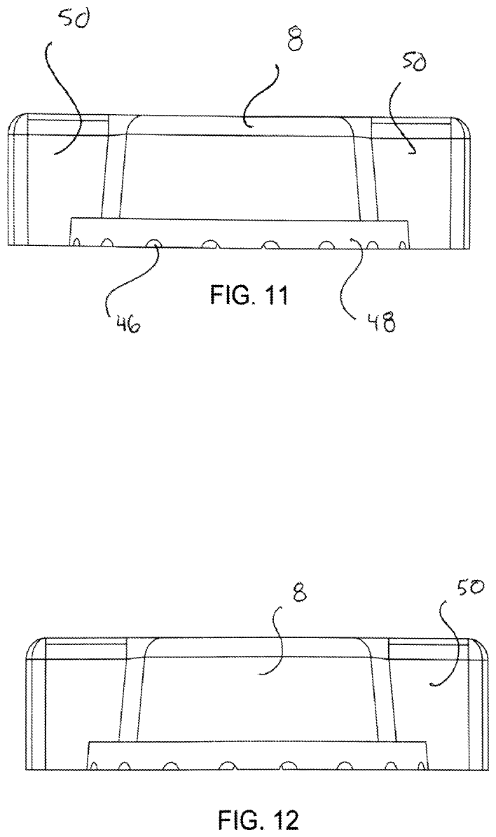

As shown in FIGS. 9, 10, 11 and 12 the wing nut 8 has an internal thread 28 sized for threaded engagement with the threaded stud 10. There is a flange 48 formed on the back of the wing nut 8. The back face 44 of the flange 48 of the wing nut 6 has a series of equidistant radial slots 46 formed thereon that are used to help trap the trellis wire between the wingnut 8 and the wire grooves 22 and 24 on the front face 20 of the trellis body 4. The wing nut 8 has a pair of wings 50 extending outwardly therefrom to enable hand tightening without the need for tools to secure the trellis lock 2 to a plant's trunk.

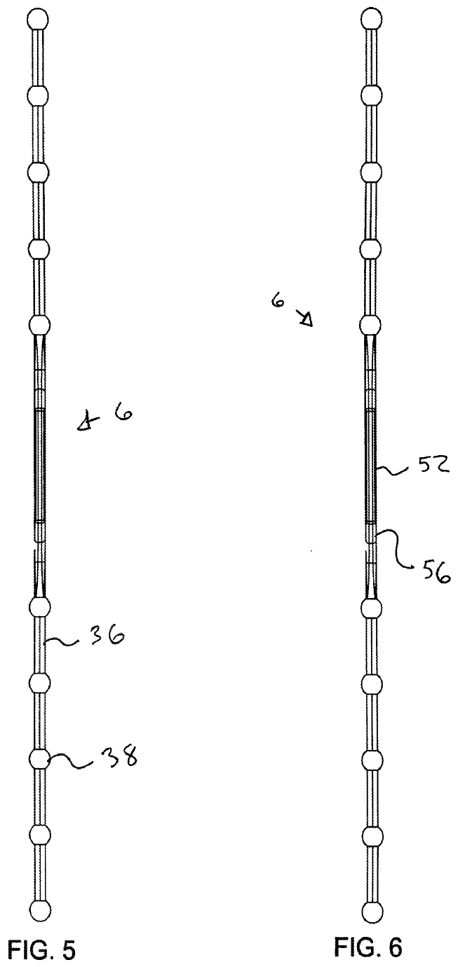

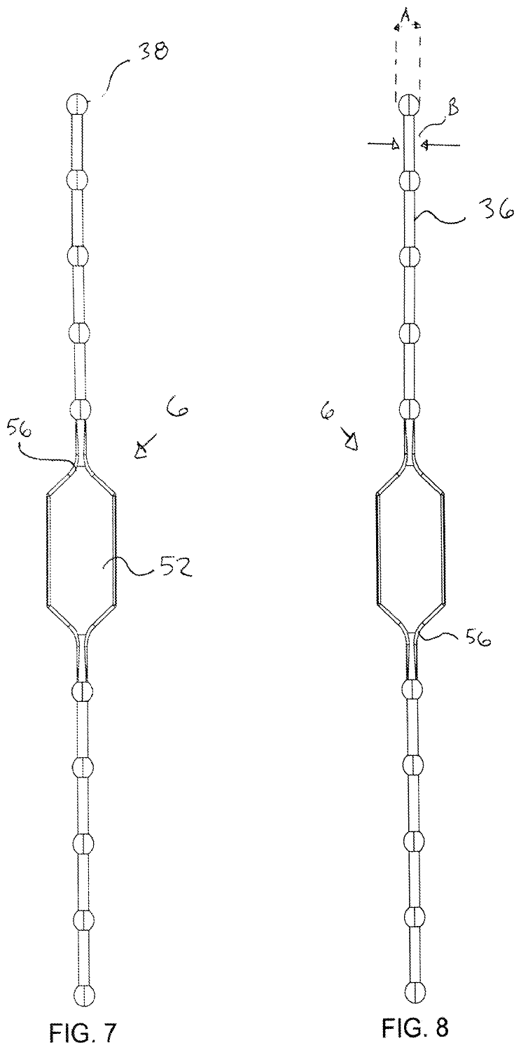

The speed strap 6 is seen from all sides in FIGS. 5-8. The speed strap 6 has a planar, central sling 52 that has a pair of elastic tails 36 extending 180 degrees apart from opposite ends 56 of the sling 52. Spaced long the tails 36 are a series of spheres 38 having a diameter A (FIG. 8) that exceeds the diameter B (FIG. 8) of the remainder of the tail 36. The diameter of these spheres 38 is larger than the width C (FIG. 2) of the T shaped slot 30. This prevents the loosening of the speed strap 6 as the spheres 38 cannot be drawn backwards through the slot 30.

The method of using the trellis lock has the following steps:

Loosening the wing nut 8 partially off of the threaded stud 10;

Determining if the horizontal trellis wire fits best in the first wire groove 22 or the second wire groove 24 on the front face 20 of the trellis lock body 4;

Placing a section of the horizontal trellis wire into contact with either the first wire groove 22 or second wire groove 24, depending on which was determined to fit best.

Tightening the wing nut 8 down the threaded stud 10 until the back face 44 of the flange 48 of the wing nut 6 contacts the horizontal trellis wire residing in the first wire groove 22 or second wire groove 24 and frictionally secures the trellis lock body 4 to the horizontal trellis wire;

Positioning a plant below the trellis lock body 4 and bringing its vertical trunk into contact with the insert 18 in the concave arced section 14 formed centrally on the rear face 12 of the trellis lock body 4;

Inserting a first one end of an elastic tail 36 of a speed strap 6 into one of the T slots shaped slots 30 on a first side of the trellis lock body 4;

Wrapping the speed strap 6 around the trunk of the plant such that the central sling 52 contacts the plant's trunk approximately 180 degrees around the trunk from when the trunk contacts the insert 18;

Inserting a second end of the elastic tail 36 of the speed strap 6 into one of the T slots shaped slots 30 on a second side of the trellis lock body 4 such that the speed strap 6 is drawn taut about the trunk, with one of each of the retention spheres 38 on both the first end and second end of the speed strap 6 contacting the front face 20 of the trellis lock body 4, and the central sling 52 contouring about a portion of the trunk's perimeter.

Optionally, using a second speed strap 6 to further secure the trellis lock 2 to the plant's trunk following the method of the preceding three steps.

In more general terms the method of securing a plant trunk to a horizontal trellis wire comprises the steps of:

Loosening a flanged primary mechanical fastener on a trellis lock body;

Determining if the horizontal trellis wire fits best in a first wire groove or a second wire groove on a front face of the trellis lock body;

Placing a section of the horizontal trellis wire into contact with the wire groove that was determined to best fit the horizontal trellis wire.

Tightening the flanged primary mechanical fastener until its flange frictionally secures the trellis lock body to the horizontal trellis wire;

Positioning a plant below the trellis lock body and bringing its vertical trunk into contact with a concave arced section formed centrally on the rear face of the trellis lock body;

Inserting an end of a first elastic tail of a speed strap into one of the slots formed in a first side of the trellis lock body;

Wrapping the speed strap around the trunk of the plant such that a central sling of the speed strap is disposed around a portion of the plant's trunk approximately 180 degrees around the trunk from when the trunk contacts the concave arced section on the trellis lock body;

Inserting an end of a second elastic tail of the speed strap into one of the slots on a second side of the trellis lock body 4 such that the speed strap is drawn taut about the trunk;

Optionally, using a second speed strap 6 to further secure the trellis lock to the plant's trunk following the method of the preceding three steps.

It is to be noted that while the wire trellis lock herein has been described as a device for securing a plant's trunk in a vertical orientation, it is also intended for use with other elements desired to be secured in a vertical of upright position such as posts, stakes and the like. However, one of the main features of the trellis lock is that it eliminates the need for individual stakes or posts to be driven into the ground adjacent a plant and secured to the plant's trunk.

The wingnut 8 and the threaded stud 10 formed on the front face of the trellis lock body 4, taken together constitute the flanged primary mechanical fastener. It is known that this combination may be replaced by other flanged mechanical fastener equivalents such as flanged push nuts, flanged speed nuts, U or J speed nut clips, flanged barrel speed nuts or the equivalent.

While certain features and aspects have been described with respect to exemplary embodiments, one skilled in the art will recognize that numerous modifications are possible. Moreover, while the procedures of the methods and processes for building, assembling and using the device described herein is described in a particular order for ease of description, unless the context dictates otherwise, various procedures may be reordered, added, and/or omitted in accordance with various embodiments. Consequently, although but one exemplary embodiment is described above, it will be appreciated that the invention is intended to cover all modifications and equivalents within the scope of the following claims.

1. A trellis wire lock for securing a vertical trunk of a plant to a horizontal trellis wire, comprising:
a rectangular trellis lock body having a front face with first half mechanical fastener extending directly therefrom, a rear face with a concave arced section formed centrally there across having a polymer insert affixed therein, and at least two slots formed between said front face and said rear face, each of said slots emanating from a peripheral edge on opposing sides of said lock body;
a second half mechanical fastener engageable with said first half mechanical fastener; and
at least one speed strap comprising an elastic member with a series of spheres formed along a length thereof and having a central sling said spheres frictionally restrained from passing through one of said at least two slots.

2. The trellis wire lock of claim 1, further comprising:
a concave cutout formed across said concave rear face; and
wherein said insert is affixed onto said concave cutout, said insert made of a first material more compressible than a second material said trellis lock body is fabricated from.

3. The trellis wire lock of claim 2 wherein said first half mechanical fastener is a threaded stud extending perpendicularly from said front face and said second half mechanical fastener is a flanged wing nut engageable on said threaded stud.

4. (canceled)

5. (canceled)

6. The trellis wire lock of claim 5, wherein the slots are T shaped and the number of slots is four; and
wherein the number of speed straps is two.

7. The trellis wire lock of claim 6, further comprising:
a first wire groove formed in said front face;
a second wire groove formed in said front face, wherein said second wire groove has a depth profile deeper than a depth profile of said first wire groove; and
a series of equidistant radial slots 46 formed on a back face of the flange of the wing nut.

8. The method of securing a plant trunk to a horizontal trellis wire of claim 6 further comprising:
Loosening a flanged primary mechanical fastener on a trellis lock body;
Placing a section of the horizontal trellis wire into contact with either a first or a second wire groove on the front face of the trellis lock body, based on a diameter size of said trellis wire;
Tightening the flanged primary mechanical fastener until its flange frictionally secures the trellis lock body to the horizontal trellis wire;
Positioning a plant below the trellis lock body and bringing its vertical trunk into contact with a concave arced section formed centrally on the rear face of the trellis lock body;
Inserting an end of a first elastic tail of a speed strap into one of the slots formed in a first side of the trellis lock body;
Wrapping the speed strap around the trunk of the plant such that a central sling of the speed strap is disposed around a portion of the plant's trunk that is approximately 180 degrees away from where when the trunk contacts the concave arced section on the trellis lock body;
Inserting an end of a second elastic tail of the speed strap into one of the slots on a second side of the trellis lock body 4 such that the speed strap is drawn taut about the trunk.

9. The method of using a trellis lock to connect to a trellis wire where the trellis lock is made of a trellis lock body having a front face with a threaded stud extending therefrom, a concave rear face with an insert thereon, and at least two slots formed on opposing sides of said trellis lock body between said front face and said rear face, each of said slots emanating from a peripheral edge, a flanged wingnut engageable with said threaded stud, and at least one elastic, speed strap having a central sling with two ends, each with an elastic tail extending therefrom, where the tails are frictionally engageable within one of the slots, comprising the steps of:
loosening the wing nut partially off of the threaded stud;
placing a section of the horizontal trellis wire into contact with either a first wire groove or a second wire groove on the front face of the trellis lock body, based on a diameter size of said trellis wire;
tightening the wing nut down the threaded stud until the back face of the flange of the wing nut contacts the horizontal trellis wire residing in the first wire groove or second wire groove and frictionally secures the trellis lock body to the horizontal trellis wire;
positioning a plant below the trellis lock body and bringing its vertical trunk into contact with the insert in the concave arced section formed centrally on the rear face of the trellis lock body;
inserting a first one end of an elastic tail of a speed strap 6 into one of the T slots shaped slots on a first side of the trellis lock body;
wrapping the speed strap around the trunk of the plant such that the central sling contacts the plant's trunk approximately degrees around the trunk from when the trunk contacts the insert;
inserting a second end of the elastic tail of the speed strap into one of the T slots shaped slots on a second side of the trellis lock body such that the speed strap is drawn taut about the trunk, with one of each of the retention spheres on both the first end and second end of the speed strap contacting the front face of the trellis lock body, and the central sling contouring about a portion of the trunk's perimeter.
